(19) United States
(12) Patent Application Publication
(10) Pub. No.: US 2019/0032708 A1
(43) Pub. Date: Jan. 31, 2019

(54) BEARING ARRANGEMENT FOR SUPPORTING A SHAFT OF A GEARBOX

(71) Applicant: Zollern BHW Gleitlager GmbH & Co. KG, Braunschweig (DE)

(72) Inventors: Edgar GUST, Wolfenbuttel (DE); Thilo KOCH, Duderstadt (DE); Mathias BERTRAM, Katlenburg-Lindau (DE); Abdelhakim LAABID, Gottingen (DE)

(21) Appl. No.: 16/044,059

(22) Filed: Jul. 24, 2018

(30) Foreign Application Priority Data
Jul. 25, 2017 (DE) 10 2017 116 786.2

(51) Int. Cl. F16C 19/38

(52) U.S. Cl. CPC F16C 19/38; F16C 2361/61

(57) ABSTRACT

The invention relates to a bearing arrangement (1) for supporting a shaft of a gearbox, the bearing arrangement comprising at least two radial bearings and at least two axial bearings, at least one of the radial bearings being a plain bearing and comprising a bearing surface (6), which is formed by at least one bushing insert (8) arranged on a backing (2) and at least one of the axial bearings, preferably both axial bearings, being a tilting pad bearing having a plurality of tilting pads (10).

The invention relates to a bearing arrangement for supporting a shaft of a gearbox. The invention further relates to a gearbox for a wind turbine, which comprises at least one shaft which is supported by such a bearing arrangement, and to a wind turbine having such a gearbox.

Wind turbines have steadily grown in size over recent years and decades and are nowadays are often used in inaccessible or hard-to-reach locations, such as offshore areas out at sea. At the same time offshore wind turbines, in particular, have the advantage of being exposed to relatively constant wind conditions, so that the electrical current yield is particularly high. Furthermore, there are no complaints about nuisance from residents, so that the design of wind turbines can be optimized, particularly in terms of their size and arrangement. Today's wind turbines often have a blade length of more than 60 m, so that particularly in stiffer winds and high winds immense stresses act on the rotor of the wind turbine and thereby also on the shaft, on which the rotor turns. The rotation of the shaft is converted, often by a multi-stage gearbox, before it is delivered to the actual generator.

Gearboxes for such wind turbines, in particular, but also gearboxes for other applications must fulfil a number of requirements. For example, they must withstand the enormous stresses that can be generated by the prevailing wind and yet still take up as little overall space as possible, since the nacelle, that is the actual machine housing of the wind turbine, should be designed as small as possible. In the offshore sector, in particular, it is moreover important to provide gearboxes that are as maintenance-free and unsusceptible to faults as possible, since maintenance and repair out at sea are extremely difficult and very cost-intensive.

As a rule, gearboxes of wind turbines have one or more planetary gear stages, so that different forms of shaft have to be supported in different ways. The prior art discloses the use of rolling-contact bearings in the form of self-aligning roller bearings and cylindrical roller bearings, for example, which in practice, however, have not proved sufficiently unsusceptible to faults. The insusceptibility to faults and low maintenance of the bearing is, however, one of the critical requirements since, as already outlined, maintenance is possible only with great difficulty and a failure of one of the planetary bearings of a wind turbine generally leads to complete failure of the unit. Such a failure is obviously to be avoided if at all possible.

In the case of planetary gears, in particular, an additional challenge is that the individual shafts need to be supported not only in a radial bearing but also by an axial bearing against a possible movement in an axial direction.

The object of the invention is to propose a bearing arrangement for supporting a shaft of a gearbox which is compact but unsusceptible to faults, thereby requiring little maintenance, whilst still affording optimum bearing characteristics.

The invention achieves the stated object by means of a bearing arrangement for supporting a shaft of a gearbox, the bearing comprising at least two radial bearings and at least two axial bearings, at least one of the radial bearings being a plain bearing and comprising a bearing surface which is formed by at least one bushing insert arranged on a backing, and at least one of the axial bearings, preferably both axial bearings, being a tilting pad bearing having a plurality of tilting pads.

The use of a plain bearing as radial bearing affords a very reliable type of radial bearing not susceptible to faults. The backing, which is advantageously composed of steel and may be of one-piece or multipiece design, has an axial opening, through which the shaft to be supported is led. This opening is lined with at least the one bushing insert, which may be pressed into the backing, for example. The bushing insert may equally be of multipart design and advantageously extends over the entire circumference of the opening in the backing.

The two radial bearings are advantageously spaced at a distance from one another in the longitudinal direction of the shaft to be supported. In this way it is possible to ensure a secure support in a radial direction. The two axial bearings are advantageously designed to support the shaft in two opposing axial directions. Thus, one of the axial bearings is preferably adapted to absorbing forces in a first axial direction, for example to the right, whilst the other of the two axial bearings is adapted to absorbing forces in the opposite axial direction, in this case to the left. In this way a comprehensive support is achieved.

The tilting pads of at least one of the axial bearings are advantageously arranged on one of the backings of one of the radial bearings. In this way a bearing is formed which comprises both at least one of the axial bearings and one of the radial bearings. Such a bearing can be used for a wide variety of applications and constitutes a separate invention. In a preferred embodiment such a bearing comprises one of the two radial bearings and axial bearing elements, in particular tilting pads, at the two end faces of the corresponding backing, in order to afford the axial bearing support.

Such a bearing, which comprises a radial bearing and at least one axial bearing, preferably two axial bearings, can be equipped with all the embodiments described here.

The bushing insert advantageously comprises at least two layers, one of which, the so-called back, is the side remote from the opening. It is preferably detachably connected to the backing and is advantageously likewise composed of steel. The radially inner layer of the bushing insert is the so-called running layer, which constitutes the actual bearing metal layer. It is preferably composed of a plain bearing metal, for example white metal, bronze, a plastic, aluminum or an aluminum alloy, in particular an aluminum-tin alloy, for example AlSn20 or AlSn40.

Such a radial bearing does not have any moving parts, so that the wear and hence the amount of maintenance are very low.

In addition, the bearing arrangement comprises at least one axial bearing, preferably two axial bearings, which is a tilting pad bearing having a plurality of tilting pads. Here a plurality in particular means at least two tilting pads.

In order to prevent the shaft being able to move in an axial direction, at least the two axial bearings are provided. Particularly in the case of the shaft that is connected to the rotor of a wind turbine, but also with other shafts used in a gearbox, significant forces can quite well in the operation of the bearing, the shaft and/or the gearbox in the axial direction of the shaft. These need not always be distributed uniformly over the cross section of the shaft but are quite capable of assuming different magnitudes at different points. In particular they may vary as a function of the rotational speed of the shaft and the operating mode, for example of the gearbox. At least the one axial bearing, preferably both axial bearings, therefore comprise a plurality of tilting pad bearings, which are supported in a special mounting, and are capable of tilting about at least one axis, preferably in relation to point of support. They are tilted into the optimum position by the rotating shaft itself, so that an optimum bearing support is possible in any situation. The segments, as already outlined, are each capable of tilting, in order to ensure that they adjust optimally to the operating state, which depends, in particular, on the rotational speed and the load acting on the shaft. It has been shown that tilting pads are capable of supporting a load as so-called multi-surface bearings. The individual tilting pads are supplied with a lubricant, in particular an oil, in order to minimize the friction. Oil feed ducts, which deliver fresh oil, are preferably provided for this purpose. At least one oil feed duct is advantageously provided for each tilting pad. In addition, the individual tilting pad may also be supplied via side flow of the oil from the radial bearing.

The bushing insert of at least the two radial bearings is usually produced from a composite body. For this purpose, the plain bearing metal, for example the white metal or the aluminum alloy, can be applied directly onto the backing or onto the inside of the bushing insert, or centrifugally cast, for example. The embodiment of the bearing according to the invention, however, as the advantage of being able to use other bearing metals, for example bronze alloys or even plastics, by production methods known in the art, in that the bushing insert is integrated into the backing. This can be done, for example, by press or shrink methods, resulting in a pressed or shrunk bond.

The tilting pads are advantageously arranged equidistantly on an axial end face of the backing, at least over portions but preferably over the entire circumference, in a circumferential direction of the shaft to be supported. The equidistant or at least equidistant positioning of the tilting pads over portions leads to an optimum distribution over the circumference and therefore to the greatest possible uniformity in the distribution of pressure by the shaft on the individual tilting pads. It may also be advantageous, however, particularly where the backing is composed of multiple backing components, which are assembled and connected to one another when assembling the bearing, to provide an equidistant distribution of the tilting pads only on the parts of the end face which are each formed by one of the backing components.

Alternatively, the individual tilting pads may also not be arranged equidistantly. This, too, is advantageous in certain situations. The tilting pads form the axial bearing and are therefore intended to absorb forces acting in an axial direction. In operation, however, these forces can fluctuate and in so doing not only change in their strength and their direction, resulting in a reversal of thrust, but also occur at different distances from the axis of rotation of the shaft. Thus it is possible, for example, for large axial compressive forces to occur in certain situations, but then always in a predefined area, for example beneath the axis of rotation. In other situations, axial compressive forces of significantly lesser strength occur, but are situated above the axis of rotation. In this situation it is advantageous to provide more tilting pads below the axis of rotation, that is in the area in which large thrust and compressive forces occur, than in the area above the axis of rotation, that is in the area in which, although thrust forces occur, they are significantly weaker. Moreover, it can also happen that the shaft to be supported tilts, so that in this way, too, unevenly distributed forces have to be absorbed by at least one of the axial bearings.

The backing is advantageously closed at one end face, a plurality of tilting pads being arranged on this end face. The bearing is then of cupped designed and the shaft to be supported is pushed into this bearing. In this case the tilting pads of the axial bearing are arranged radially inside the radial bearing. If the bearing arrangement is not closed at any of the end faces and the shaft to be supported is led right through the bearing arrangement, this is naturally not possible, so that the tilting pads are arranged radially outside the bearing surface of the radial bearing.

In a preferred embodiment at least the one bushing insert is detachably arranged on the backing. This allows easy replacement of the bushing insert should this be necessary, for example due to wear or abrasion, or for maintenance purposes. The bearing more preferably comprises at least two radial bearings spaced at a distance from one another in an axial direction. The bearing more preferably comprises two axial bearings, which are preferably arranged on two opposite end faces of the backing. The bearing arrangement may obviously also be used for supporting multiple shafts, at least one shaft being supported in a radial direction by the radial bearing, for example, and at least one other shaft being supported in an axial direction by the axial bearing. The bearings preferably comprise multiple radial bearings, however, and multiple axial bearings, so as to be able, if possible, to support all shafts of the gearbox. In this way an especially high stability is achieved, with little susceptibility to distortion.

An oil baffle ring is preferably situated between the backing and at least one of the tilting pads, but preferably all tilting pads.

The invention furthermore achieves the stated object by means of a gearbox for a wind turbine, which comprises at least one spur gear stage having at least one shaft, which is supported by a bearing arrangement, preferably at least two bearing arrangements, according to one of the preceding claims. It has proved particularly advantageous if more than one, preferably all shafts of the spur gear stage are supported by the bearing arrangement according to one of the preceding claims.

The invention furthermore achieves the stated object by means of a wind turbine having a gearbox of the type described here.

Some exemplary embodiments of the present invention are explained in more detail below with the aid of the drawing, in which:

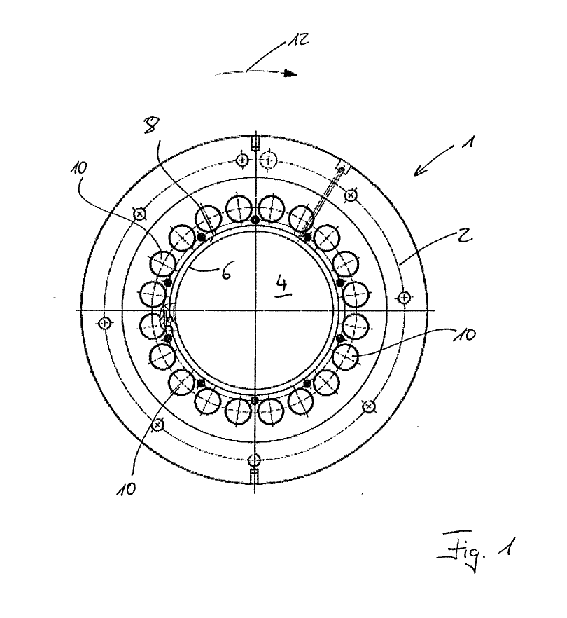

FIG. 1 shows the schematic representation of a bearing in an axial direction,

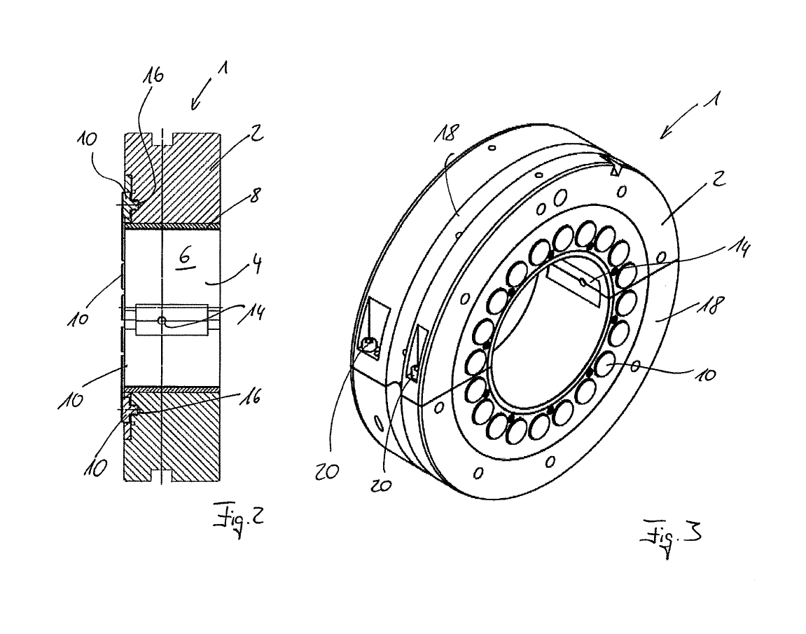

FIG. 2 shows a sectional representation through the bearing shown in FIG. 1 and

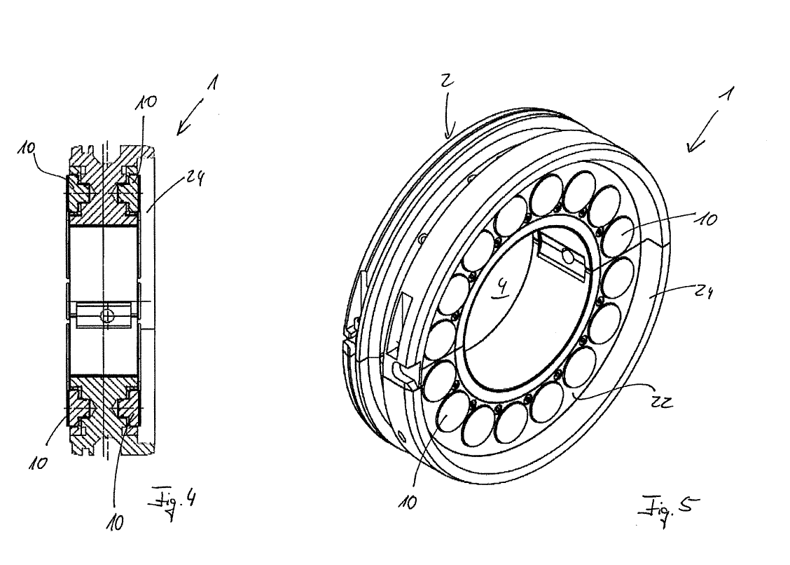

FIG. 3 shows a schematic 3D view of the bearing in FIGS. 1 and 2,

FIG. 4 shows the schematic sectional representation through a bearing according to a further exemplary embodiment of the present invention,

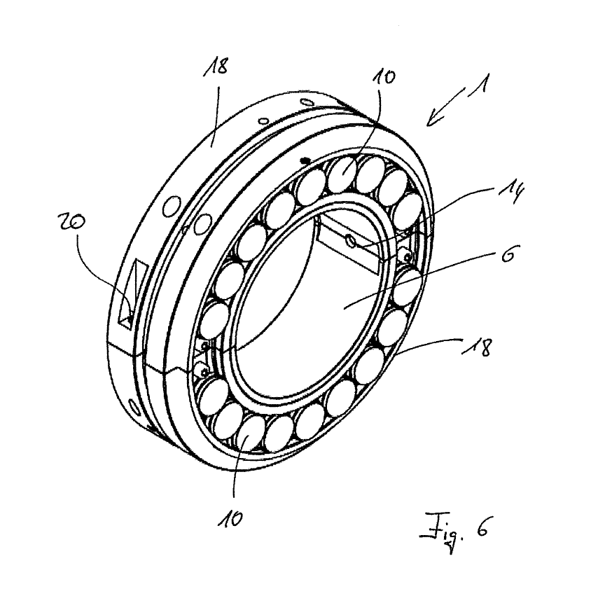

FIG. 5 shows the schematic three-dimensional view of the bearing in FIG. 4 and

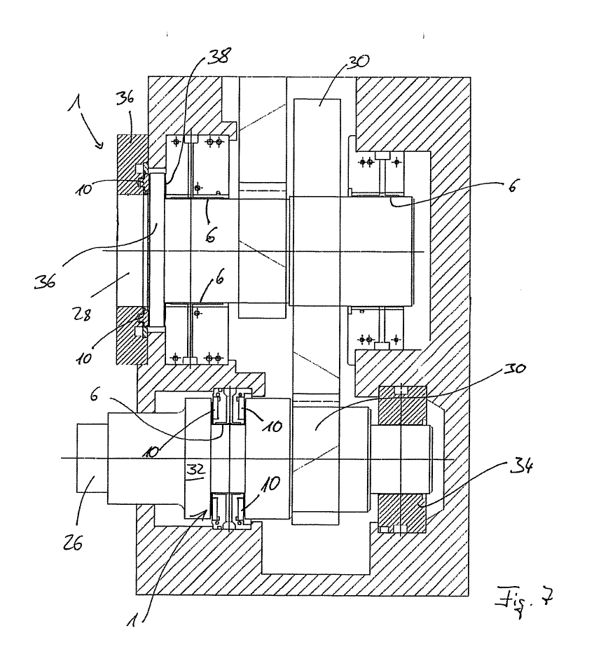

FIG. 6 shows the schematic representation of a bearing according to a further exemplary embodiment of the present invention and

FIG. 7 shows the schematic sectional representation through a gearbox, in which bearings according to exemplary embodiments in the present invention are used.

FIG. 1 shows a bearing, which can be used as part of a bearing arrangement 1 according to a first exemplary embodiment of the present invention. It comprises a backing 2, which has a central opening 4, through which a shaft (not shown) can be led. The central opening 4 is surrounded by a bearing surface 6, which forms a radially inner surface of a bushing insert 8. In the exemplary embodiment shown the bushing insert is formed from two pieces. Alternatively, however, one-piece and multipiece bushing inserts 8 and/or multipiece backings 2 are also feasible.

A plurality of tilting pads 10, which form the bearing surface of the bearing, are represented around the central opening 4. In the exemplary embodiment shown they are distributed equidistantly over the circumference and thus ensure an optimum absorption of the load of a shaft to be supported. In operation a shaft, which is led through the central opening 4, will rotate in the direction of the arrow 12.

FIG. 2 shows a schematic sectional representation through the bearing in FIG. 1. The backing and the central opening 4 are clearly visible. An oil feed 14, which serves to lubricate the bearing surface 6 and hence the axial bearing, is shown in the bearing surface 6 of the bushing insert 8. Alternatively, it is also possible to use multiple oil feeds 14, particularly in order to duct oil into different bearings, for example into a radial bearing and into an axial bearing. Multiple tilting pads 10 are shown, of which two are represented in cross section. They are designed to pivot around a point of support 16 in virtually all directions. The point of support 16 obviously need not be a point in the mathematical sense, but may be present as a surface, which may also be of curved, domed or plane design formation.

FIG. 3 shows the bearing in a slightly modified embodiment. It can be seen that the backing 2 comprises two backing elements 18, which are each of semi-circular design. They are fixed to one another by fasteners 20. The oil feed 14 and the individual tilting pads 10 are also shown.

FIGS. 4 and 5 show a further embodiment of the bearing. A circumferential edge 24, which projects in an axial direction relative to the central axis of the central opening 4 over the tilting pads 10, is arranged radially outside the tilting pads 10, which in turn are arranged in an end face 22 of the backing 2. This is also represented in FIG. 4, which shows a sectional representation through the bearing 1 in FIG. 5. It can be seen in the sectional representation in FIG. 4 that the bearing comprises two axial bearings, which each have a plurality of tilting pads 10. The one axial bearing, which is also represented in FIG. 5, is formed from the tilting pads 10 represented on the right in FIG. 4. These are set back in an axial direction from the circumferential edge 24. The edge 24 serves for introducing axially acting forces into an adjoining bearing body (not shown). In FIG. 4 tilting pads 10 oriented towards the left are not set back behind an edge but are arranged in the end face 22, as represented in FIGS. 1 to 3. There is no axial bearing support for an element radially supported at this point.

FIG. 6 shows a further embodiment of the bearing, which comprises two backing elements 18, which are fixed to one another by fasteners 20. The bearing surface 6, the oil feed 14 and the various tilting pads 10 can also be seen in this figure. Unlike those in the embodiments previously shown, however, the tilting pads 10 are not distributed equidistantly over the whole circumference. At two points where the two backing elements 18 are contiguous with one another there are no corresponding tilting pads 10, so that here a gap occurs in the otherwise equidistant distribution.

FIG. 7 shows a section through a gearbox. The via a first shaft 26 and a second shaft 28, on each of which a gearwheel 30 is arranged, which mesh with one another. Two bearing arrangements 1 are used. The first shaft 26 is supported by a bearing arrangement 1, in which a bearing supported according to an exemplary embodiment of the present invention, which comprises the bearing surface 6 of the radial bearing and the tilting pads 10 of the axial bearings. It can be seen that a flange 32, which protrudes over the actual first shaft 26 in a radial direction and thus bears on the tilting pads 10 of the bearing 1, is arranged on the first shaft 26. Since such a flange is also arranged on the opposite side of the bearing, the bearing comprises corresponding tilting pads 10 on both sides in an axial direction. In the right-hand area of FIG. 7 the first shaft 26 is supported by a further radial bearing 34, so that altogether two radial bearings and two axial bearings are available for supporting the first shaft 26.

This is different in the case of the bearing arrangement 1 which serves to support the second shaft 28. This bearing arrangement, too, obviously has bearing surfaces 6 for radial support. One of the corresponding bearing bodies comprises a multi-surface bearing 38, which forms one of the two axial bearings. The second axial bearing is designed as a separate axial bearing 36 and comprises tilting pads 10, which serve to brace and support the axially occurring forces.

### LIST OF REFERENCE NUMERALS

1 bearing arrangement
2 backing
4 central opening
6 bearing surface
8 bushing insert
10 tilting pad
12 arrow
14 oil feed
16 point of support
18 backing element
20 fastener
22 end face
24 edge
26 first shaft
28 second shaft
30 gearwheel
32 flange
34 radial bearing
36 axial bearing
38 multi-surface bearing

1. A bearing arrangement for supporting a shaft of a gearbox, the bearing arrangement comprising
at least two radial bearings, at least one of the radial bearings being a plain bearing comprising a backing and at least one bushing insert arranged on the backing, the plain bearing comprising a bearing surface which is formed by the least one bushing insert; and
at least two axial bearings, at least one of the axial bearings being a tilting pad bearing comprising a plurality of tilting pads.

2. The bearing arrangement according to claim 1, wherein the tilting pads of at least one of the axial bearings are arranged on the backing of one of the radial bearings.

3. The bearing arrangement according to claim 2, wherein the tilting pads are arranged equidistantly on an axial end face of the backing, over at least portions of the entire circumference in a circumferential direction of the shaft to be supported.

4. The bearing arrangement according to claim 2, wherein the backing is closed at one end face on which the plurality of tilting pads are arranged.

5. The bearing arrangement according to claim 1, wherein the bearing surface is produced from a white metal, bronze, plastic, aluminum or aluminum alloy.

6. The bearing arrangement according to claim 1, wherein the at least one bushing insert is detachably arranged on the backing.

7. The bearing arrangement according to claim 1, wherein the at least two radial bearings are spaced at a distance from one another in an axial direction.

8. The bearing arrangement according to claim 1, wherein two of the at least two axial bearings are arranged on two opposite end faces of the backing.

9. The bearing arrangement according to claim 1, further comprising an oil feed ring situated between the backing and at least one of the tilting pads.

10. A gearbox for a wind turbine, comprising
at least one spur gear stage comprising at least one shaft; and
at least one bearing arrangement supporting the at least one shaft, the at least one bearing arrangement comprising
at least two radial bearings, at least one of the radial bearings being a plain bearing comprising a backing and at least one bushing insert arranged on the backing, the plain bearing comprising a bearing surface which is formed by the least one bushing insert; and
at least two axial bearings, at least one of the axial bearings being a tilting pad bearing comprising a plurality of tilting pads.

11. The gearbox according to claim 10, wherein the at least one spur gear stage comprises a plurality of shafts and the at least one bearing arrangement consists of a plurality of bearing arrangements, and wherein more than one of the shafts of the spur gear stage are each supported by at least one of the bearing arrangements.

12. A wind turbine having a gearbox, the gearbox comprising
at least one spur gear stage comprising at least one shaft; and
at least one bearing arrangement supporting the at least one shaft, the at least one bearing arrangement comprising
at least two radial bearings, at least one of the radial bearings being a plain bearing comprising a backing and at least one bushing insert arranged on the backing, the plain bearing comprising a bearing surface which is formed by the least one bushing insert; and
at least two axial bearings, at least one of the axial bearings being a tilting pad bearing comprising a plurality of tilting pads.

13. The bearing arrangement according to claim 1, wherein two or more of the at least two axial bearings are tilting pad bearings having a plurality of tilting pads.

14. The bearing arrangement according to claim 3, wherein the tilting pads are arranged equidistantly on the axial end face of the backing over an entire circumference in a circumferential direction of the shaft to be supported.

15. The bearing arrangement according to claim 5, wherein the bearing surface is produced from an aluminum-tin alloy.

16. The bearing arrangement according to claim 9, wherein the oil feed ring is situated between the backing and all of the tilting pads.

17. The gearbox according to claim 10, wherein the at least one bearing arrangement consists of at least two bearing arrangements.

18. The gearbox according to claim 11, wherein all of the shafts of the spur gear stage are each supported by at least one of the bearing arrangements.
